(19) United States
(12) Patent Application Publication
(10) Pub. No.: US 2025/0200081 A1
(43) Pub. Date: Jun. 19, 2025

(54) METHOD, APPARATUS, COMPUTER DEVICE, AND STORAGE MEDIUM FOR DATA QUERY

(71) Applicant: Douyin Vision Co., Ltd., Beijing (CN)

(72) Inventors: Miao CHEN, Beijing (CN); Shuisheng ZHANG, Beijing (CN); Danchi FAN, Beijing (CN); Yuan ZHANG, Beijing (CN)

(21) Appl. No.: 18/988,087

(22) Filed: Dec. 19, 2024

(30) Foreign Application Priority Data
Dec. 19, 2023 (CN) 202311754487.8

(51) Int. Cl. G06F 16/3329; G06F 16/34

(52) U.S. Cl. CPC G06F 16/3329; G06F 16/345

(57) ABSTRACT

The present disclosure relates to the field of data visualization technologies, and discloses a data query method and apparatus, a computer device, and a storage medium. The present disclosure provides a data query method, including: displaying a data query page, where the data query page includes a data query control; obtaining a data query statement based on an interaction with the data query control, and displaying the data query statement on the data query page; and displaying, on the data query page based on the data query statement, a message card representing a query result, where the message card includes a query condition area and a visual display area, the query condition area is configured to display a query condition corresponding to the data query statement, and the data visual display area is configured to display data corresponding to the query condition.

### CROSS-REFERENCE TO RELATED APPLICATION(S)

This application claims priority to Chinese Application No. 202311754487.8 filed Dec. 19, 2023, the disclosure of which is incorporated herein by reference in its entity.

### FIELD

The present disclosure relates to the field of data visualization technologies, and specifically to a method, apparatus, computer device, and storage medium for data query.

### BACKGROUND

Data acquisition and analysis is one of key steps of data analysis, and is used to provide a reliable basis for subsequent data analysis and decision-making.

### SUMMARY

In view of the above, the present disclosure provides a method and apparatus, a computer device, and a storage medium for data query, to solve the problem of low efficiency of data query.

According to a first aspect, the present disclosure provides a method for data query, including:
displaying a data query page, wherein the data query page comprises a data query control;
obtaining a data query statement based on an interaction with the data query control, and displaying the data query statement on the data query page; and
displaying, on the data query page and based on the data query statement, a message card representing a query result, wherein the message card comprises a query condition area and a visual display area, the query condition area is configured to display a query condition corresponding to the data query statement, and the data visual display area is configured to display data corresponding to the query condition.

According to a second aspect, the present disclosure provides a data query apparatus, including:
a first display module, configured to display a data query page, wherein the data query page comprises a data query control;
an obtaining module, configured to obtain a data query statement based on an interaction with the data query control, and display the data query statement on the data query page; and
a second display module, configured to display, on the data query page based on the data query statement, a message card representing a query result, wherein the message card comprises a query condition area and a visual display area, the query condition area is configured to display a query condition corresponding to the data query statement, and the data visual display area is configured to display data corresponding to the query condition.

According to a third aspect, the present disclosure provides a computer device, including: a memory and a processor, wherein the memory and the processor are in communication connection with each other, computer instructions are stored in the memory, and the processor executes the computer instructions to perform the method for data query according to the first aspect or any of the corresponding implementations.

According to a fourth aspect, the present disclosure provides a computer-readable storage medium, wherein the computer-readable storage medium is stored with computer instructions, and the computer instructions are used to cause a computer to perform the data query method according to the first aspect or any of the corresponding implementations.

### BRIEF DESCRIPTION OF THE DRAWINGS

In order to more clearly describe the specific implementations of the present disclosure or the technical solutions in the prior art, the accompanying drawings to be used in the description of the specific implementations or the prior art will be briefly described below. It is clear that the accompanying drawings in the following description show some implementations of the present disclosure, and a person of ordinary skill in the art may still derive other drawings from these drawings without creative efforts.

FIG. 1 is a flowchart of a data query method according to an embodiment of the present disclosure;

FIG. 2 is a schematic diagram of an interface of a query condition area according to an embodiment of the present disclosure;

FIG. 3 is a schematic diagram of an interface of another query condition area according to an embodiment of the present disclosure;

FIG. 4 is a schematic diagram of an interface of a condition query edit area according to an embodiment of the present disclosure;

FIG. 5 is a schematic diagram of an interface of still another query condition area according to an embodiment of the present disclosure;

FIG. 6 is a schematic diagram of an interface of a condition menu according to an embodiment of the present disclosure;

FIG. 7 is a schematic diagram of an interface of still another query condition edit area according to an embodiment of the present disclosure;

FIG. 8 is a schematic diagram of an interface of still another query condition edit area according to an embodiment of the present disclosure;

FIG. 9 is a schematic diagram of an interface of a chart type menu according to an embodiment of the present disclosure;

FIG. 10 is a schematic diagram of an interface of a chart function operation area according to an embodiment of the present disclosure;

FIG. 11 is a schematic diagram of an interface of an anomaly detail page according to an embodiment of the present disclosure;

FIG. 12 is a schematic diagram of a display position of a data summary text according to an embodiment of the present disclosure;

FIG. 13 is a schematic diagram of an interface of an attribute detail page according to an embodiment of the present disclosure;

FIG. 14 is a flowchart of another data query method according to an embodiment of the present disclosure;

FIG. 15 is a schematic diagram of an interface of a disambiguation detail page according to an embodiment of the present disclosure;

FIG. 16 is a schematic diagram of an interface of another disambiguation detail page according to an embodiment of the present disclosure;

FIG. 17 is a schematic diagram of an interface of still another disambiguation detail page according to an embodiment of the present disclosure;

FIG. 18 is a block diagram of a structure of a data query apparatus according to an embodiment of the present disclosure; and

FIG. 19 is a schematic diagram of a hardware structure of a computer device according to an embodiment of the present disclosure.

### DETAILED DESCRIPTION

To make the objectives, technical solutions, and advantages of the embodiments of the present disclosure clearer, the technical solutions in the embodiments of the present disclosure will be described clearly and completely below with reference to the accompanying drawings in the embodiments of the present disclosure. It is clear that the described embodiments are some but not all of the embodiments of the present disclosure. All other embodiments obtained by a person of ordinary skill in the art based on the embodiments of the present disclosure without creative efforts shall fall within the protection scope of the present disclosure.

In the related technologies, a tool for value extraction analysis needs to rely on input code or a related function to perform a value extraction operation. However, when a user does not have an ability to write a data query language, the user cannot perform data query by himself/herself, and needs to rely on help of a related professional. In addition, before performing data query, the related professional needs to understand a data query requirement of the user, and then can perform targeted query, thereby affecting timeliness of data.

In view of this, the present disclosure provides a method for data query, to display a data query page, so that a data query statement of data to be queried can be obtained and displayed through a data query control in the data query page. Based on the obtained data query content, a message card representing a query result is displayed on the data query page, so that the user may quickly and intuitively view the query result through the message card, thereby making the data query more convenient and intelligent, and helping to ensure timeliness of data. The message card includes: a query condition area and a visual display area, the query condition area is configured to display a query condition corresponding to the data query statement, and the data visual display area is configured to display data corresponding to the query condition, so that the user may quickly learn a data screening range of the query result and extracted corresponding data through the message card.

According to an embodiment of the present disclosure, there is provided an embodiment of a method for data query, which needs to be noted that the steps shown in the flowcharts of the accompanying drawings can be executed in a computer system such as a set of computer-executable instructions, and although a logical order is shown in the flowcharts, in some cases, the steps shown or described can be executed in an order different from that herein.

In practical applications, because a user does not have an ability to write a data query language, when data needs to be obtained for data analysis, the user needs to rely on related technicians to help obtain the data, thereby affecting timeliness of the data.

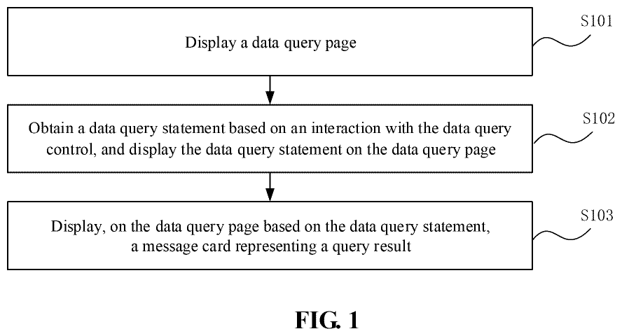

In this embodiment, a method for data query is provided, which can be used for a computer device such as a tablet computer. FIG. 1 is a flowchart of a data query method according to an embodiment of the present disclosure. As shown in FIG. 1, the process includes the following steps.

Step S101: displaying a data query page.

The data query page includes a data query control. The data query page may be understood as a page for inputting and executing data query. That is, the data query page is an externally displayed page of a tool for performing data query. The data query control is a tool or component for constructing and executing data query.

Step S102: obtaining a data query statement based on an interaction with the data query control, and displaying the data query statement on the data query page.

To reduce a data query threshold and facilitate the user to quickly obtain required data, the data query control may be externally displayed in a form of an input box, and the user may be guided to input a data query statement of data to be queried in a form of a dialogue, thereby helping to reduce the data query difficulty and making an interaction manner of data query more friendly.

After the data query statement is obtained, the data query statement is displayed on the data query page, so that the user may understand specific logic and conditions executed in a current query, and when a subsequently displayed query result does not meet an expectation of the user, the user may perform targeted error correction and correction conveniently.

Step S103: displaying, on the data query page and based on the data query statement, a message card representing a query result.

The message card includes a query condition area and a visual display area. The query condition area is configured to display a query condition corresponding to the data query statement, so that the user may learn how to construct an effective query condition and logic. The data visual display area is configured to display data corresponding to the query condition, so that the user may more intuitively extract obtained data based on the current data query statement.

In an example, the query condition may be determined by identifying a keyword in the data query statement. The query condition includes but is not limited to any of the following or a combination thereof: time granularity, time range, detail filtering, result filtering, dimension grouping, indicator, sorting, and the like. The content of the query condition depends on the received data query statement.

The data query method provided in this embodiment may directly use the data query statement obtained from the data query page to perform data query, and display a query result through the message card, so that the user may perform data query in a more convenient and intelligent manner, thereby ensuring that the user may quickly obtain a required query result and helping to ensure timeliness of data.

In an alternative implementation, in response to determining that the number of the query conditions are multiple, the query condition area is configured to display a query condition corresponding to the data query statement, including: displaying, in the query condition area, query logic corresponding to the plurality of query conditions. The query logic is a text formed by arranging the plurality of query conditions in a natural language, and the query condition includes a condition name and a corresponding value range. That is, when there are too many query adjustments, to enhance readability of the query logic, the plurality of query conditions is arranged in the natural language, and then the formed text is used as the query logic corresponding to the plurality of query conditions, so that the user may quickly understand the query logic during reading.

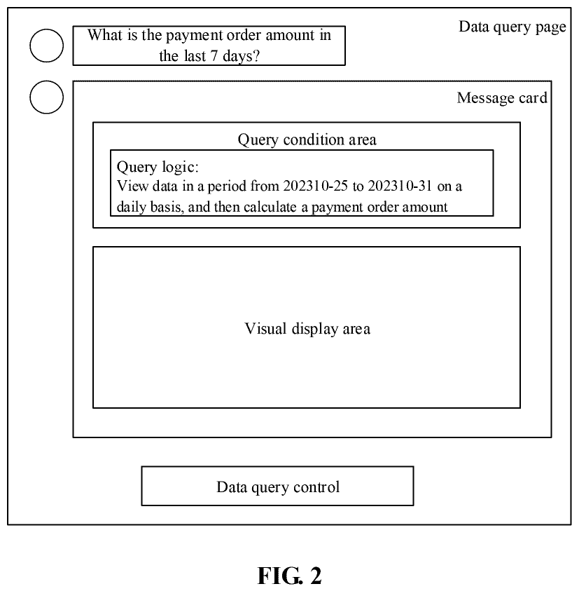

For example, as shown in FIG. 2, if the obtained data query statement is “What is the payment order amount in the last 7 days?”, the corresponding query conditions respectively relate to time granularity (by day), time range (2023-10-25 to 2023 Oct. 31), and indicator (payment order amount), and then query logic correspondingly displayed in the query condition display area is: View the data from Oct. 25, 2023 to Oct. 31, 2023 by day, and then calculate the payment order amount.

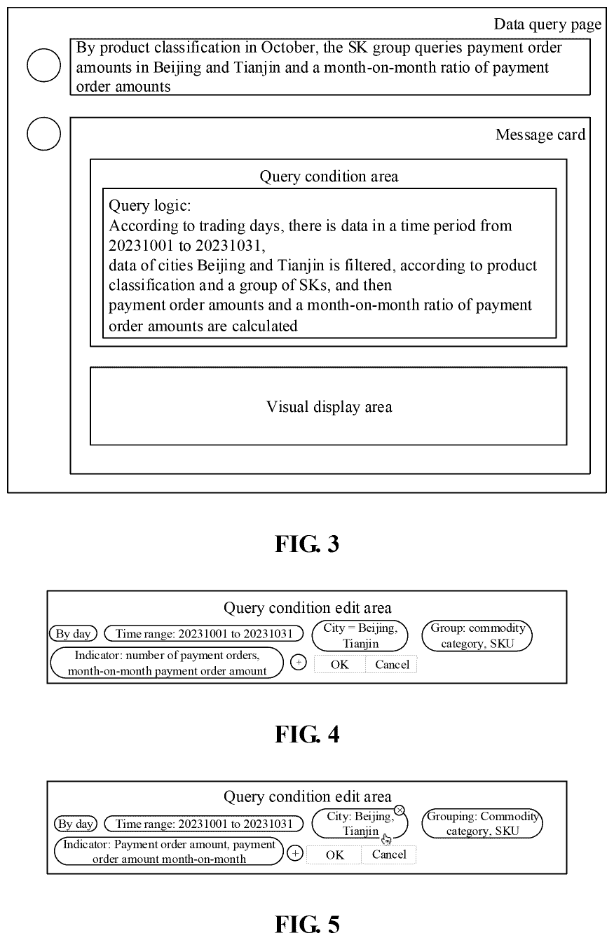

For another example, as shown in FIG. 3, if the obtained data query statement is “Query payment order amount and month-on-month payment order amount in Beijing and Tianjin in October by commodity category and SKU”, the corresponding query conditions respectively relate to time granularity (by day), time range (Jan. 10, 2023 to Oct. 31, 2023), detail filtering (Beijing and Tianjin), dimension grouping (commodity category and SKU), and indicator (payment order amount and month-on-month payment order amount), and then query logic correspondingly displayed in the query condition display area is: View the data from Oct. 1, 2023 to Oct. 31, 2023 by day, filter the data of cities of Beijing and Tianjin, group the data by commodity category and SKU, and then calculate the payment order amount and the month-on-month payment order amount.

In some alternative implementations, the query condition area further comprises a query condition edit control, and the method further comprises: displaying a query condition edit area in response to an interaction with the query condition edit control, and the query condition edit area is configured to display an editable control corresponding to the query condition. That is, to improve an interaction capability of data query and facilitate the user to quickly improve the query condition and improve data query quality, the query condition edit control is set in the query condition area, so that when the user is not satisfied with a current query result or cannot directly express the query result in words, the query condition edit area is called and displayed in response to an interaction of the user with the query condition edit control, so that the user may manually improve the query condition and refine the query logic through the query condition edit area, thereby causing the data query more flexible, efficient, and accurate.

In an alternative implementation scenario, the query condition edit control may be a “modify” control shown in FIG. 3. In response to the “modify” control being touched, a condition query edit area shown in FIG. 4 is displayed. To facilitate the user to distinguish the query conditions, the corresponding query conditions are echoed by using editable controls in a capsule style.

In some alternative implementations, a mandatory query condition is marked with a first identifier, and an optional query condition is marked with a second identifier in the query condition edit area, so that the user may perform targeted modification on the query condition to be queried through the identifier. The mandatory query condition is a query condition that can only be modified but cannot be deleted. The optional query condition is a query condition that may be deleted or modified. In an example, the mandatory query condition or the optional query condition may be marked with different colors. That is, the first identifier and the second identifier respectively correspond to different colors, and then when the user edits each query condition in the query condition edit area, the edit attribute corresponding to each query condition may be quickly distinguished through the color, thereby helping to improve the edit efficiency.

Further, the method for data query further comprises the following steps.

Step a1: Identify an editable control to be selected in the query condition edit area.

Step a2: In response to determining that a query condition corresponding to the editable control to be selected is an optional query condition, display a deletion control on a specified area of the editable control to be selected.

Step a3: Delete the editable control to be selected in response to an interaction with the deletion control.

Step a4: In response to determining that a query condition corresponding to the editable control to be selected is a mandatory query condition, do not display the deletion control.

Step a5: Update the query condition edit area based on a currently retained editable control.

Specifically, a position where a cursor stays is tracked, and when the cursor hovers on an editable control, the editable control is identified as the editable control to be selected. In response to determining that a query condition corresponding to the editable control to be selected is an optional query condition, a deletion control shown in FIG. 5 is displayed on a specified area of the editable control to be selected, to prompt that the query condition corresponding to the editable control can be deleted.

If the user performs an interaction with the deletion control, the editable control is deleted from the query condition edit area.

In response to determining that a query condition corresponding to the editable control to be selected is a mandatory query condition, the deletion control is not displayed, to prompt that the query condition corresponding to the editable control cannot be deleted.

To facilitate the user to determine a currently retained query condition, the query condition edit area is updated based on the currently retained editable control, so that the user may continuously improve the required query condition.

In some alternative implementations, the query condition edit area further comprises an add control, and the method further comprises: displaying a condition menu in response to an interaction with the add control.

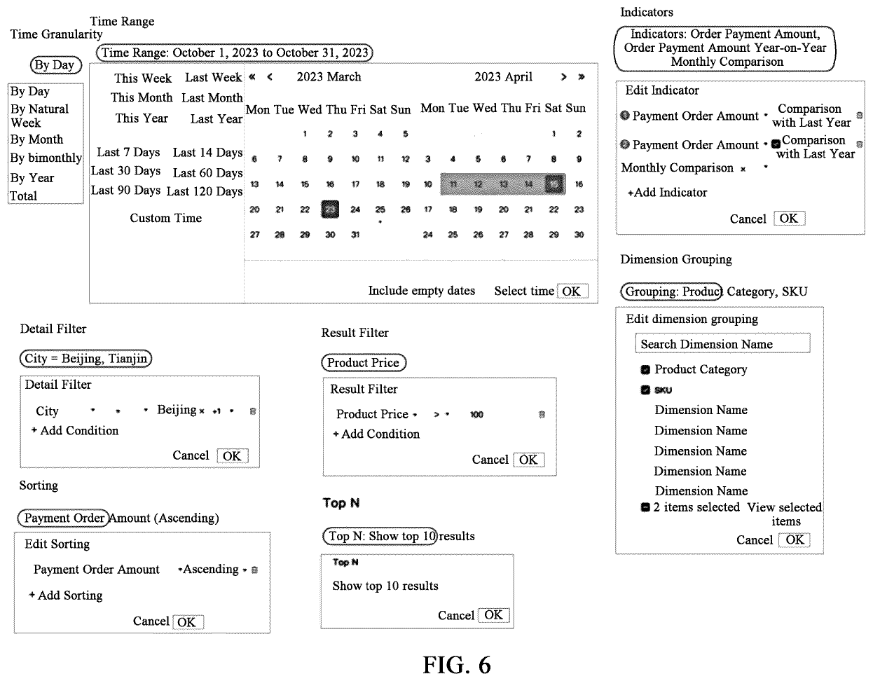

As shown in FIG. 5, an identifier of the add control may be “+”. When the user needs to improve the query condition and refine the query logic, the interaction with the add control may be implemented by means of a touch manner such as a single click or a double click, and then the condition menu shown in FIG. 6 is displayed. The condition menu is configured to provide a plurality of candidate query conditions and a condition detail page corresponding to the candidate query condition, and the condition detail page is configured to determine a condition name of the candidate query condition and/or a value range corresponding to the condition name.

For example, if the candidate query condition is time granularity, in the condition detail page, the condition name and the corresponding value range included in the time granularity are: by day, by natural week, by month, by two months, by year, and summary, and then the condition name and/or the value range corresponding to the condition name may be displayed in the corresponding condition detail page.

If the candidate query condition is a time range, in the condition detail page, a condition name included in the time range is a specific time period, for example: this week, last week, this month, last month, this year, or last year; and a corresponding value range may be: the past 7 days, the past 14 days, the past 30 days, the past 60 days, the past 90 days, the past 120 days, or custom time.

If the candidate query condition is an indicator, in the condition detail page, a condition name included in the indicator may be a payment order amount, and a corresponding value range may be a week-on-week or month-on-month ratio. The condition name included in the indicator depends on a field in which a current user is allowed to perform data query.

If the candidate query condition is detail filtering, in the condition detail page, a condition name included in the detail filtering may be a city, and a corresponding value range may be a specific city name.

If the candidate query condition is result filtering, in the condition detail page, a condition name included in the detail filtering may be a commodity price, a transaction amount, or the like, and a corresponding value range is a custom valid value range.

If the candidate query condition is dimension grouping, in the condition detail page, the condition name included in the dimension grouping may be a commodity category, a stock keeping unit (SKU), or the like.

If the candidate query condition is sorting, in the condition detail page, a condition name included in the sorting may be a sorted object (for example: payment order amount) and a specified arrangement order.

If the candidate query condition is a number of result display (TOP N), the number of display may be customized in the condition detail page.

In an alternative example, except for detail filtering and result filtering, the number of additions of other query conditions is 1, and after a query condition is added, the query condition is removed from the condition menu, thereby avoiding a situation of repeated limitation and interference of a query result.

In some alternative implementations, the method further comprises: determining an added query condition, and the added query condition is a candidate query condition that is selected to be added; and adding an editable control corresponding to the added query condition to the query condition edit area, to update the query logic.

Specifically, each condition detail page has a confirmation control. When a confirmation control on a current condition detail page is touched, a candidate query condition corresponding to the current condition detail page may be determined as the added query condition, and then the editable control corresponding to the added query condition is added to the query condition edit area, to update the query logic.

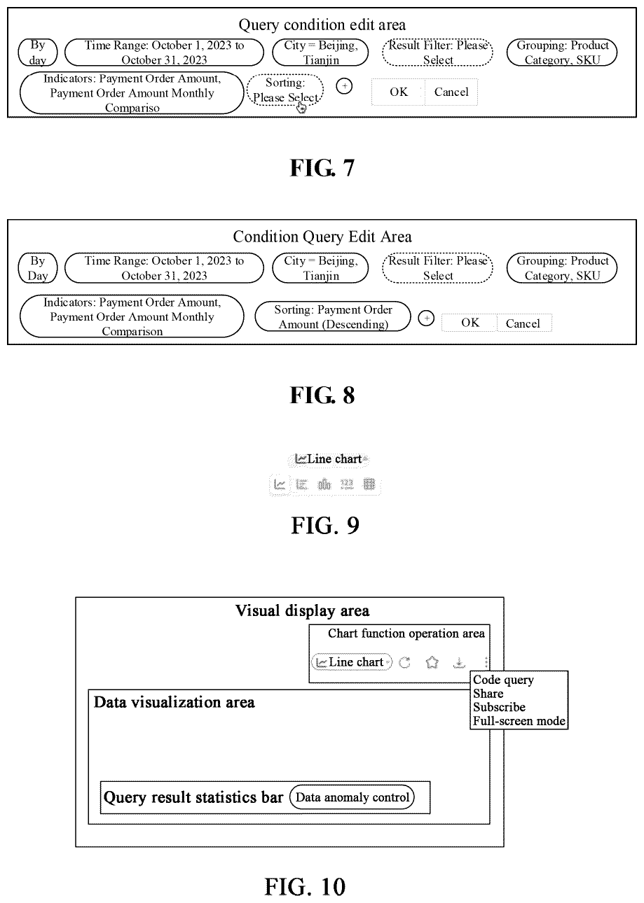

In an alternative implementation scenario, as shown in FIG. 7, after the added query condition is determined, the editable control corresponding to the added query condition is added to the query condition edit area, and is marked by using a capsule style with a dotted frame, to guide the user to perform an interaction on the editable control. In response to an interaction with the added query condition, a condition detail page corresponding to the added query condition is displayed, so that the user may perform targeted configuration on the added query condition based on other query conditions.

In another alternative implementation scenario, as shown in FIG. 8, after the added query condition is configured, the editable control corresponding to the added query condition is marked by using a capsule style with a solid line, so that the user may distinguish, through the identifier, which editable controls are configured and which editable controls are not configured, thereby improving the edit efficiency of the user for the query condition.

In still another alternative implementation scenario, the added query condition belongs to an optional query condition. Therefore, when the added query condition is determined as the editable control to be selected, a deletion control is displayed on a specified area (for example: the upper left corner) of the added query condition, so that when the user does not need the added query condition, the added query condition can be deleted, to ensure that the query condition corresponding to the currently retained editable control in the query condition edit area is the query condition required by the user.

In some alternative implementations, the query condition edit area further comprises an area controlling control, and the method further comprises: determining, in response to an interaction with the area controlling control, a current query condition corresponding to a current editable control in the query condition edit area, and hiding the query condition edit area; and updating the query logic based on the current query condition, and displaying the updated query logic in the query condition area. That is, as shown in FIG. 5, the area controlling control includes “OK” and “Cancel”. If an interaction performed on “OK” is responded, the current query condition in the query condition edit area is used as a query condition to be updated for data query, and then the query logic is updated based on the current query condition, and the updated query logic is displayed in the query condition area. If an interaction performed on “Cancel” is responded, a query condition before the query condition edit area is modified is restored, and the restored query condition in the query condition edit area is used as the current query condition, so that the query logic is updated based on the current query condition, and the updated query logic is displayed in the query condition area.

In some alternative implementations, the visual display area comprises a chart function operation area and a data visualization area, and the chart function operation area comprises a chart type menu, and the data visual display area is configured to display data corresponding to the query condition, comprising:
Step b1: Determine a target chart type in response to an interaction with the chart type menu, and the target chart type is a candidate chart type that is selected from a plurality of candidate icon types;
Step b2: Generate a target chart based on the target chart type; and Step b3: Display the target chart in the data visualization area.

Specifically, to facilitate the user to perform targeted analysis on the query result, an icon type menu shown in FIG. 9 is provided in the chart function operation area, so that the user may select a required target chart type from the plurality of candidate icon types, thereby meeting personalized requirements of the user for viewing the query result. The candidate icon types may include but are not limited to any of the following chart types: a line chart, a bar chart, a pie chart, a table, and the like.

After the user selects the target chart type from the plurality of candidate icon types, the data corresponding to the query condition is used to generate a corresponding target chart based on the target chart type, and the generated target chart is displayed in the data visualization area, so that the user may view a data change trend more intuitively.

In an alternative example, if the user does not select the target chart type, a default chart type may be used as the candidate chart type. The default chart type may be any of the plurality of candidate icon types.

In some alternative implementations, the chart function operation area further comprises a plurality of function operation controls, and the method further comprises: performing, in response to an interaction with a target function operation control, an operation function corresponding to the target function operation control. The target function operation control is a selected function operation control. The operation function includes but is not limited to any of the following functions: refreshing, favoriting, downloading, sharing, subscribing, code query, or full-screen mode. The refreshing may ensure data timeliness, and when the page is stayed for a long time, the user can easily refresh data. The favoriting helps to perform data tracking and monitoring in the later period, without the need to repeatedly ask for obtaining. The downloading is convenient for data result export. The sharing may be used for collaboration and sharing with others. The subscribing may be used to send a query result in a form of a daily report or a weekly report, thereby meeting a use requirement of the user. The code query is used to view execution code of data query, so that a professional may view or obtain a value extraction logic for executing data query. The full-screen mode is used to display the obtained target chart in full screen, thereby facilitating the user to view data details.

In some alternative implementation scenarios, in response to determining that the target function operation control is a code query control, the operation function corresponding to the target function operation control comprises: calling and displaying execution code for generating the target chart, thereby facilitating the user to determine accuracy of data through code query, and improving the trust of the user.

In some alternative implementations, the chart function operation area further comprises a function menu; the plurality of function operation controls comprises a first function operation control and a second function operation control, the first function operation control is directly displayed in the chart function operation area, and the second function operation control is hidden in the function menu. The method further comprises: displaying the second function operation control in response to an interaction with the function menu. That is, because display sizes of screens of computer devices are different, display areas of the chart function operation area also differ. To ensure integrity of functions and avoid excessive occupation of the display areas of the chart function operation area, some function operation controls may be hidden in the function menu, and then when the user needs to perform the second function operation control hidden in the function menu, the second function operation control required can be obtained from the expanded function menu by performing an interaction on the function menu. In some alternative implementation scenarios, as shown in FIG. 10, from left to right, the chart type menu, refreshing, favoriting, and downloading may be used as the first function operation control, and are directly displayed in the chart function operation area, and code query, sharing, subscribing, and full-screen mode may be used as the second function operation control, and are hidden in the function menu, so that when the function menu is touched, the second function operation control is displayed.

In some alternative implementation scenarios, as shown in FIG. 10, the data visualization area further comprises a query result statistics bar. The query result statistics bar is configured to display a data query total amount of the query result and an anomaly detection result of performing anomaly detection on the query result, so that the user may more intuitively learn data conditions through the query result statistics bar, thereby facilitating the user to better manage data.

In some alternative implementations, the data visualization area further comprises a data anomaly control, the data anomaly control is configured to display an anomaly detection result in the query result, and the method further comprises: displaying an anomaly detail page of the anomaly detection result in response to an interaction with the data anomaly control.

Specifically, after the query result is obtained, self-exploration detection is performed on the query result, to identify whether there is anomaly data. If anomaly data is identified, the anomaly detection result is displayed by using the data anomaly control, to prompt the user that there is anomaly data in the query result.

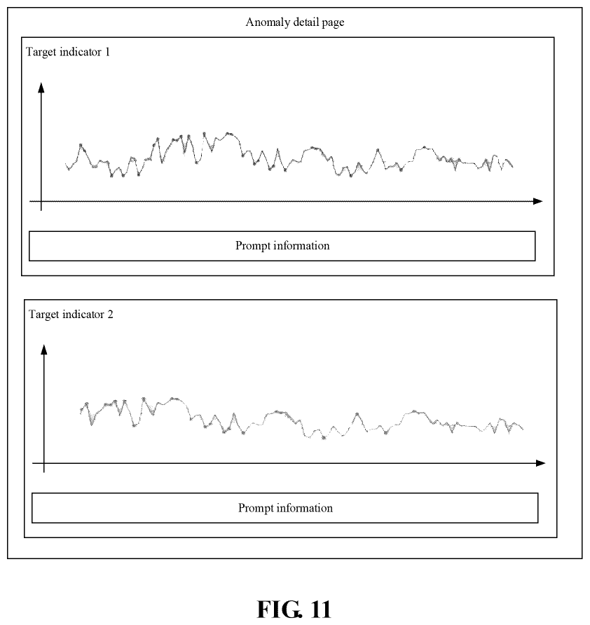

When an interaction performed by the user on the data anomaly control is detected, the anomaly detail page is called and displayed, so that the user can more intuitively learn details of the anomaly data, thereby avoiding a risk caused by the data anomaly in time. In an alternative implementation scenario, the anomaly detail page includes: a target indicator with anomaly data, a target line chart, and prompt information. The target line chart is configured to represent data corresponding to the target indicator, and the prompt information is configured to prompt a location of the anomaly data. If there is one target indicator, only details of related anomaly data of the target indicator are displayed in the anomaly detail page. If the number of target indicators are multiple, as shown in FIG. 11, details of related anomaly data of each target indicator are displayed item by item in the anomaly detail page.

In an alternative implementation scenario, to facilitate the user to quickly learn the content of the anomaly detection result, the number of anomaly indicators is displayed on the data anomaly control, to prompt a source of the anomaly data.

In some alternative implementations, the message card further comprises a function recommendation area, the function recommendation area is configured to display a data summary control, and the method further comprises: generating and displaying a data summary text of the query result in response to an interaction with the data summary control. To improve data reading and analysis efficiency, the data summary control is further provided in the displayed message card, so that when the user performs an interaction on the data summary control, intelligent analysis can be performed on the query result, and the data summary text of the query result is generated and displayed, thereby facilitating the user to quickly learn core content of the query result through the generated data summary text.

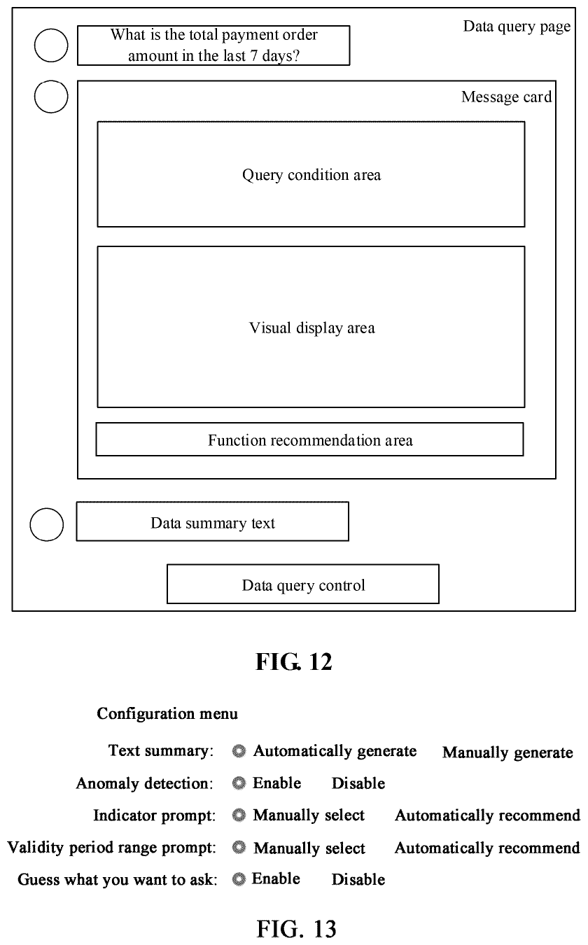

In an alternative implementation scenario, as shown in FIG. 12, the generated data summary text may be located under the message card.

In some alternative implementations, the data query page further comprises a configuration menu, and the method further comprises: displaying a display attribute detail page of the message card in response to an interaction with the configuration menu. The display attribute detail page is configured to adjust display content of the message card. By displaying the attribute detail page, the user may quickly learn the display content of the message card, thereby performing targeted configuration, so that the content displayed on the message card more meets personalized requirements of the user.

In an alternative implementation scenario, as shown in FIG. 13, the attribute detail page may include the following configuration content: whether to actively generate a text summary, whether to enable anomaly detection, whether to recommend an indicator prompt, whether to prompt a validity period range, and whether to enable a “guess what you want to ask” function.

If it is configured to actively generate a text summary, the data summary control is not displayed, and the data summary text of the query result is automatically generated and displayed while the query result is displayed. If it is configured to manually generate a text summary, the data summary control is displayed, to generate and display the data summary text of the query result in response to an interaction with the data summary control.

If it is configured to enable anomaly detection, the query result statistics bar is displayed. If it is configured to disable anomaly detection, the query result statistics bar is not displayed.

If it is configured to manually select an indicator prompt, the user independently selects an indicator for which data query needs to be performed. If it is configured to automatically recommend an indicator prompt, after the data query statement is obtained, a related indicator may be automatically recommended in combination with a currently identified query condition, to help the user make a more personalized and own-need-compliant choice, thereby improving data query efficiency of the user.

If it is configured to manually select a validity period range prompt, the user independently selects a validity period range for which data query needs to be performed. If it is configured to automatically recommend a validity period range prompt, after the data query statement is obtained, a related validity period range may be automatically recommended in combination with a currently identified query condition, to improve data query efficiency of the user.

If it is configured to enable the “guess what you want to ask” function, a query statement related to the data query statement is pushed in combination with the obtained data query statement. For example, if the obtained data query statement is “What is the total payment order amount in the last 7 days?”, the following related query statements may be pushed on the data query page: “What is the total payment order amount in the last 14 days?”, “What is the technical caliber of the total payment order amount in the last 7 days?”, or “Why has the total payment order amount decreased in the last 7 days?”.

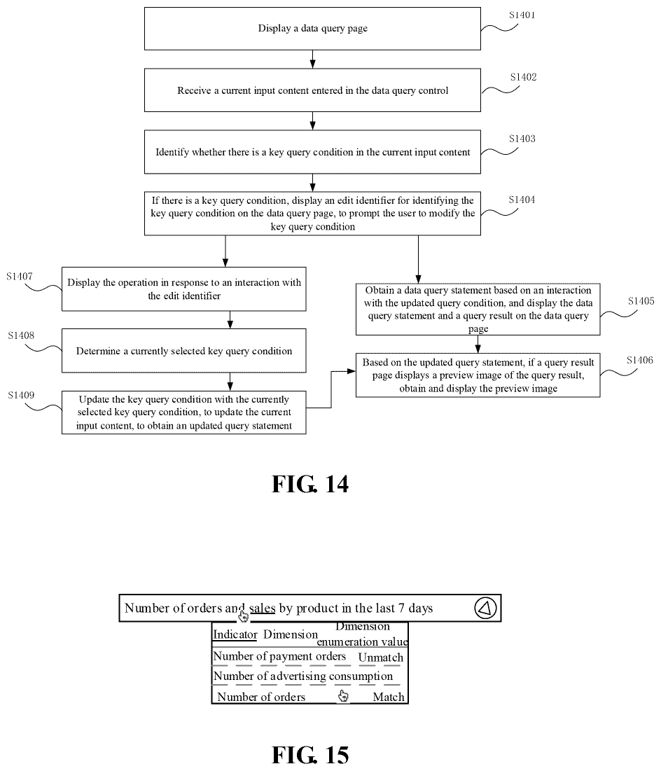

In this embodiment, a data query method is provided, which can be used for a computer device such as a tablet computer. FIG. 14 is a flowchart of a data query method according to an embodiment of the present disclosure. As shown in FIG. 14, the process includes the following steps.

Step S1401: Display a data query page.

Step S1402: Receive a current input content inputted in the data query control.

During a process in which the user enters the data query statement, the current input content inputted in the data query control is received, so that whether there is an ambiguous query condition in the current input content may be synchronously detected during the user input process.

Step S1403: Identify whether there is an ambiguous query condition in the current input content.

The ambiguous query condition may be referred to as an ambiguous query condition. If there is an ambiguous query condition in the current input content, it may lead to inability to determine which data is valid data and which data is invalid data during a data query process, thereby resulting in redundancy in a query result and affecting a user experience. Therefore, to improve data query efficiency, it is identified whether there is an ambiguous query condition in the current input content, so that the user can be prompted to disambiguate in time.

Step S1404: If there is an ambiguous query condition, display an edit control for the ambiguous query condition on the data query page, to prompt the user to modify the ambiguous query condition.

If there is an ambiguous query condition, it indicates that when data query is performed according to the data query statement confirmed based on the current input content, the query result is not accurate. Therefore, the edit control for the ambiguous query condition is displayed on the data query page, to prompt the user that the query condition is an ambiguous query condition and needs to be modified, thereby improving validity of the data query statement. In an alternative implementation scenario, a wavy underline may be added under the edit control for the ambiguous query condition, so that the user may quickly identify a location of the edit control on the data query page.

Step S1405: Obtain a data query statement based on an interaction with the data query control, and display the data query statement on the data query page.

Step S1406: Display, on the data query page based on the data query statement, a message card representing a query result.

In the data query method provided in this embodiment, ambiguity detection is performed on the current input content during a process in which the user enters the data query statement, so that the user can be promptly prompted whether there is a query condition in the current input content, thereby facilitating the user to perform targeted modification and improving data query efficiency.

In some alternative implementations, the data query method further comprises the following steps.

Step S1407: Display a disambiguation detail page in response to an interaction with the edit control.

The disambiguation detail page is configured to provide a plurality of related query conditions related to the ambiguous query condition. To facilitate the user to disambiguate in a targeted manner, the disambiguation detail page is displayed in response to the interaction with the edit control, to guide the user to determine a required related query condition from the plurality of related query conditions.

In an alternative implementation scenario, as shown in FIG. 15, if the detected ambiguous query condition is “sales”, the plurality of related query conditions displayed in the disambiguation detail page may include: “advertising consumption”, “number of orders”, “number of payment orders”, and the like.

Step S1408: Determine a currently selected related query condition.

The user may determine the current related query condition from the disambiguation detail page by using a cursor or a gesture. For example, if the computer device supports a touch operation, the current related query condition may be determined according to a current touch position of the user on the disambiguation detail page. If the computer device does not support a touch operation, the current related query condition may be determined according to a position currently clicked by the cursor.

In an alternative implementation, as shown in FIG. 15, in the disambiguation detail page, each related query condition has a corresponding “match” control. The related query condition corresponding to a current “match” control that an interaction is performed on may be used as the current related query condition.

Step S1409: Replace the ambiguous query condition with the currently selected related query condition, to update the current input content, to obtain a data query statement.

The ambiguous query condition is replaced with the currently selected related query condition, so that it can be ensured that a query condition involved in the updated current input content can clarify a data query direction, and a data query statement for targeted data query can be obtained.

The data query statement is obtained in the foregoing manner, so that it can be ensured that the obtained data query statement can clarify a query direction of data to be queried, thereby effectively reducing a situation of obtaining redundant data and improving data query efficiency.

In some alternative implementation scenarios, after the ambiguous query condition is replaced with the currently selected related query condition, an edit control corresponding to the currently selected related query condition is displayed in the data query control, so that the user may continue to modify the currently selected related query condition until the data query requirement of the user is met.

If the user needs to switch the currently selected related query condition, the edit control corresponding to the currently selected related query condition may be touched in the data query control, to display a “dismatch” control corresponding to the currently selected related query condition. If the “dismatch” control is touched, the currently selected related query condition is deleted from the current input content.

In some alternative implementations, if the related query condition is not selected, before the message card representing the query result is displayed on the data query page, the method further comprises: displaying a disambiguation card; and updating the data query statement based on the currently selected related query condition in response to the currently selected related query condition being selected.

Specifically, the disambiguation card comprises a plurality of condition selection controls, and different condition selection controls correspond to different related query conditions. If the user does not replace the ambiguous query condition in the current input content, after the data query statement is obtained, before the message card is displayed, the disambiguation card is displayed to force the user to perform disambiguation on the query condition of data to be queried, thereby ensuring effectiveness of data query.

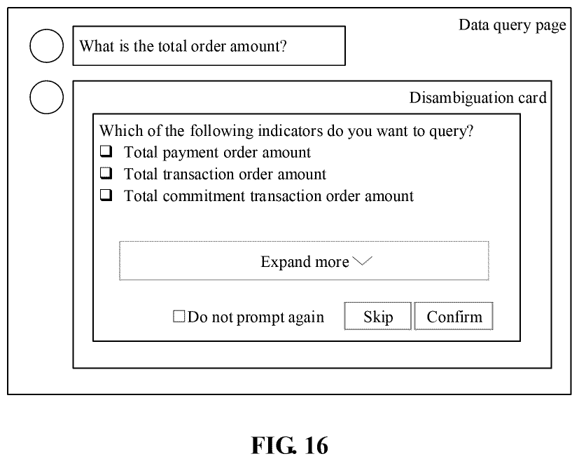

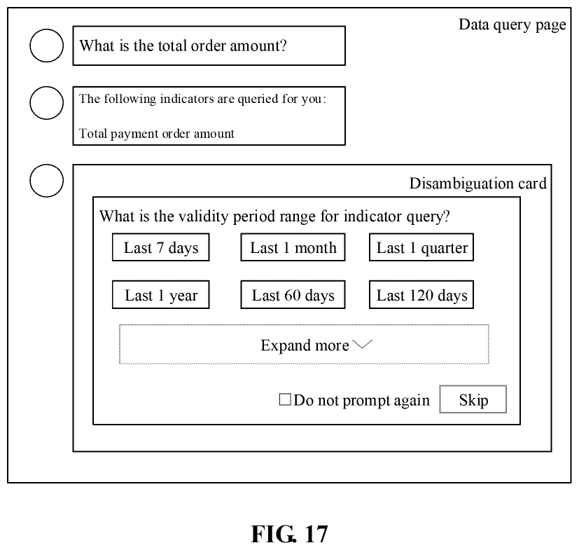

In an alternative implementation scenario, if the obtained data query statement is “What is the total order amount?”, it indicates that the ambiguous query condition is an indicator and a time range. Therefore, a disambiguation card shown in FIG. 16 is displayed to strongly guide the user to select a related indicator from a plurality of related indicators provided in the disambiguation card, and use the related indicator as a currently selected related indicator for updating the data query statement. A disambiguation card shown in FIG. 17 is displayed to strongly guide the user to select a related time range from a plurality of related time ranges provided in the disambiguation card, and the related time range is used as a currently selected related time range for updating the data query statement.

The double disambiguation manner may fully ensure integrity of query logic and effectiveness of a data query range, thereby ensuring data query quality to the greatest extent and facilitating improvement of data query efficiency.

As one or more specific application embodiments of the embodiments of the present disclosure, when the user needs to perform data query, the data query statement of data to be queried is inputted in a displayed data query page through the data query control.

If the inputted data query statement does not have an ambiguous query condition, a query result is displayed through the message card.

If the inputted data query result has an ambiguous query condition, an edit control for the ambiguous query condition is displayed on the data query page during a process in which the user enters the current input content, to prompt the user to modify the ambiguous query condition. If the user modifies the ambiguous query condition, and there is no other ambiguous query condition in the current input content, the query result is displayed through the message card.

If the obtained data query statement has an ambiguous query condition, the disambiguation card is displayed, to force the user to perform disambiguation on the query condition in the data query statement, so that when there is no ambiguous query condition in the data query statement, the query result is displayed through the message card.

By means of the data query method, non-professionals may be ensured to quickly complete a required value extraction task, and the learning cost is low. Further, during the data query process, the query condition may be manually modified, so that a data extraction manner is more flexible and convenient. In addition, the multiple disambiguation strategies may also ensure accuracy of the data query range, so that obtained data is more accurate, thereby facilitating improvement of data query efficiency.

An embodiment of the present disclosure further provides a data query apparatus, which is configured to implement the foregoing embodiments and preferred implementations, and details of which are not described again. As used below, the term “module” may implement a combination of software and/or hardware of a predetermined function. Although the apparatus described in the following embodiments is preferably implemented by software, an implementation of hardware or a combination of software and hardware is also possible and contemplated.

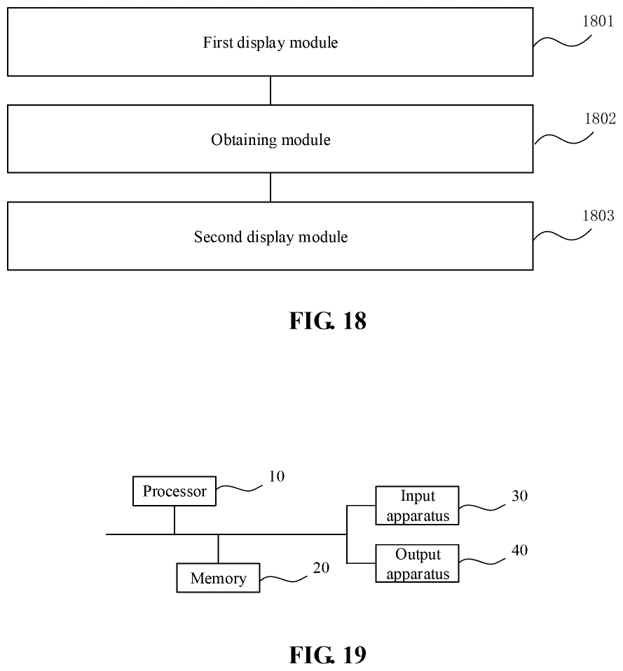

This embodiment provides a data query apparatus. As shown in FIG. 18, the apparatus includes:
a first display module 1801, configured to display a data query page, and the data query page includes a data query control;
an obtaining module 1802, configured to obtain a data query statement based on an interaction with the data query control, and display the data query statement on the data query page; and
a second display module 1803, configured to display, on the data query page based on the data query statement, a message card representing a query result, and the message card includes a query condition area and a visual display area, the query condition area is configured to display a query condition corresponding to the data query statement, and the data visual display area is configured to display data corresponding to the query condition.

In some alternative implementations, in response to determining that the number of the query conditions are multiple, the query condition area is configured to display a query condition corresponding to the data query statement, including: displaying, in the query condition area, query logic corresponding to the plurality of query conditions, wherein the query logic is a text formed by arranging the plurality of query conditions in a natural language, and the query condition includes a condition name and a corresponding value range.

In some alternative implementations, the query condition area further comprises a query condition edit control, and the apparatus further comprises:
a first processing module, configured to display a query condition edit area in response to an interaction with the query condition edit control, and the query condition edit area is configured to display an editable control corresponding to the query condition.

In some alternative implementations, a mandatory query condition is marked with a first identifier, and an optional query condition is marked with a second identifier in the query condition edit area, and the apparatus further comprises:
a first identification module, configured to identify an editable control to be selected in the query condition edit area;
a third display module, configured to display a deletion control on a specified area of the editable control to be selected in response to determining that a query condition corresponding to the editable control to be selected is an optional query condition;
a first execution module, configured to delete the editable control to be selected in response to an interaction with the deletion control;
a second execution module, configured to not display the deletion control in response to determining that a query condition corresponding to the editable control to be selected is a mandatory query condition; and
a first update module, configured to update the query condition edit area based on a currently retained editable control.

In some alternative implementations, the query condition edit area further comprises an add control, and the apparatus further comprises:
a second processing module, configured to display a condition menu in response to an interaction with the add control, and the condition menu is configured to provide a plurality of candidate query conditions and a condition detail page corresponding to the candidate query condition, and the condition detail page is configured to determine a condition name of the candidate query condition and/or a value range corresponding to the condition name.

In some alternative implementations, the apparatus further comprises:
a first determination module, configured to determine an added query condition, and the added query condition is a candidate query condition that is selected to be added; and
an addition module, configured to add an editable control corresponding to the added query condition to the query condition edit area, to update the query logic.

In some alternative implementations, the query condition edit area further comprises an area controlling control, and the apparatus further comprises:
a third processing module, configured to determine, in response to an interaction with the area controlling control, a current query condition corresponding to a current editable control in the query condition edit area, and hide the query condition edit area; and
a second update module, configured to update the query logic based on the current query condition, and display the updated query logic in the query condition area.

In some alternative implementations, the visual display area comprises a chart function operation area and a data visualization area, the chart function operation area comprises a chart type menu, and the data visual display area is configured to display data corresponding to the query condition, comprising:
a fourth processing module, configured to determine a target chart type in response to an interaction with the chart type menu, and the target chart type is a candidate chart type that is selected from a plurality of candidate icon types;
a chart generation module, configured to generate a target chart based on the target chart type, wherein the target chart is configured to represent the data corresponding to the query condition; and
a fourth display module, configured to display the target chart in the data visualization area.

In some alternative implementations, the chart function operation area further comprises a plurality of function operation controls, and the apparatus further comprises:
a third execution module, configured to perform, in response to an interaction with a target function operation control, an operation function corresponding to the target function operation control, wherein the target function operation control is a selected function operation control.

In some alternative implementations, in response to determining that the target function operation control is a code query control, the operation function corresponding to the target function operation control comprises: calling and displaying execution code for generating the target chart.

In some alternative implementations, the chart function operation area further comprises a function menu; the plurality of function operation controls comprises a first function operation control and a second function operation control, the first function operation control is directly displayed in the chart function operation area, and the second function operation control is hidden in the function menu; and
the apparatus further comprises:
a fifth display module, configured to display the second function operation control in response to an interaction with the function menu.

In some alternative implementations, the data visualization area further comprises a data anomaly control, the data anomaly control is configured to display an anomaly detection result in the query result, and the apparatus further comprises:
a sixth display module, configured to display an anomaly detail page of the anomaly detection result in response to an interaction with the data anomaly control.

In some alternative implementations, the message card further comprises a function recommendation area, the function recommendation area is configured to display a data summary control, and the apparatus further comprises:
a fifth processing module, configured to generate and display a data summary text of the query result in response to an interaction with the data summary control.

In some alternative implementations, the data query page further comprises a configuration menu, and the apparatus further comprises:
a seventh display module, configured to display a display attribute detail page of the message card in response to an interaction with the configuration menu, and the display attribute detail page is configured to adjust display content of the message card.

In some alternative implementations, before the data query statement is obtained, the apparatus further comprises:
a receiving module, configured to receive a current input content inputted in the data query control;
a second identification module, configured to identify whether there is an ambiguous query condition in the current input content; and
an eighth display module, configured to display an edit control for the ambiguous query condition on the data query page if there is an ambiguous query condition, to prompt the user to modify the ambiguous query condition.

In some alternative implementations, the apparatus further comprises:
a ninth display module, configured to display a disambiguation detail page in response to an interaction with the edit control, and the disambiguation detail page is configured to provide a plurality of related query conditions related to the ambiguous query condition;
a second determination module, configured to determine a currently selected related query condition;
and
a third update module, configured to replace the ambiguous query condition with the currently selected related query condition, to update the current input content, to obtain a data query statement.

In some alternative implementations, if the related query condition is not selected, before the message card representing the query result is displayed on the data query page, the apparatus further comprises:
a tenth display module, configured to display a disambiguation card, and the disambiguation card comprises a plurality of condition selection controls, and different condition selection controls correspond to different related query conditions; and
a fourth update module, configured to update the data query statement based on the currently selected related query condition in response to the currently selected related query condition being selected.

Further function descriptions of the foregoing modules and units are the same as those of the corresponding embodiments, and details thereof are not described herein again.

The data query apparatus in this embodiment is presented in the form of a functional unit. The unit herein refers to an ASIC (Application Specific Integrated Circuit) circuit, a processor and a memory that execute one or more software or firmware programs, and/or another device that can provide the foregoing functions.

An embodiment of the present disclosure further provides a computer device, including the data query apparatus shown in FIG. 18.

Referring to FIG. 19, FIG. 19 is a schematic structural diagram of a computer device according to an alternative embodiment of the present disclosure. As shown in FIG. 19, the computer device includes: one or more processors 10, a memory 20, and an interface for connecting components, including a high-speed interface and a low-speed interface. The components communicate with each other and are connected by using different buses, and can be mounted on a common mainboard or otherwise mounted as required. The processor may process instructions executed in the computer device, including instructions stored in or on the memory to display graphic information of a GUI on an external input/output apparatus (such as a display apparatus coupled to the interface). In some alternative implementations, if required, a plurality of processors and/or a plurality of buses may be used together with a plurality of memories and a plurality of memories. Similarly, a plurality of computer devices may be connected, and each device provides some necessary operations (for example, as a server array, a group of blade servers, or a multi-processor system). FIG. 19 shows one processor 10 as an example.

The processor 10 may be a central processing unit, a network processor, or a combination thereof. The processor 10 may further include a hardware chip. The hardware chip may be an ASIC, a programmable logic device, or a combination thereof. The programmable logic device may be a complex programmable logic device, a field programmable gate array, a general array logic, or any combination thereof.

The memory 20 is stored with instructions executable by at least one processor 10, so that the at least one processor 10 executes the method shown in the foregoing embodiment.

The memory 20 may include a program storage area and a data storage area. The program storage area may store an operating system, an application required for at least one function, and the like. The data storage area may store data created based on use of the computer device, and the like. In addition, the memory 20 may include a high-speed random access memory, and may further include a non-volatile memory, for example, at least one magnetic disk storage device, a flash memory device, or another non-volatile solid-state storage device. In some alternative implementations, the memory 20 may alternatively include a memory that is remotely disposed relative to the processor 10, and the remote memory may be connected to the computer device over a network. Examples of the network include, but are not limited to, the Internet, an intranet, a local area network, a mobile communication network, and a combination thereof.

The memory 20 may include a volatile memory, for example, a random access memory; the memory may alternatively include a non-volatile memory, for example, a flash memory, a hard disk, or a solid-state hard disk; and the memory 20 may further include a combination of the foregoing types of memories.

The computer device further includes an input apparatus 30 and an output apparatus 40. The processor 10, the memory 20, the input apparatus 30, and the output apparatus 40 may be connected by using a bus or in another manner. FIG. 19 shows an example of connection by using a bus.

The input apparatus 30 may receive inputted numeric or character information, and generate a key signal input related to user settings and function control of the computer device, such as a touchscreen, a keypad, a mouse, a trackpad, a touchpad, an indicator lever, one or more mouse buttons, a trackball, a joystick, or the like. The output apparatus 40 may include a display apparatus, an auxiliary lighting apparatus (for example, an LED), a tactile feedback apparatus (for example, a vibration motor), or the like. The display apparatus includes but is not limited to a liquid crystal display, a light-emitting diode, a display, and a plasma display. In some alternative implementations, the display apparatus may be a touchscreen.

An embodiment of the present disclosure further provides a computer-readable storage medium. The method according to the embodiment of the present disclosure may be implemented in hardware or firmware, or may be implemented as computer code originally stored in a remote storage medium or a non-transitory machine-readable storage medium and to be stored in a local storage medium that may be recorded in the storage medium or downloaded over a network, so that the method described herein may be stored in such software processing on a storage medium using a general-purpose computer, a dedicated processor, or programmable or dedicated hardware. The storage medium may be a magnetic disk, an optical disc, a read-only memory, a random access memory, a flash memory, a hard disk, a solid-state hard disk, or the like. Further, the storage medium may further include a combination of the foregoing types of memories. It may be understood that a computer, a processor, a microprocessor controller, or programmable hardware includes a storage component that may store or receive software or computer code, and when the software or computer code is accessed and executed by the computer, the processor, or the hardware, the method shown in the foregoing embodiment is implemented.

It may be understood that before the technical solutions disclosed in the embodiments of the present disclosure are used, the types, use ranges, use scenarios, and the like of personal information involved in the present disclosure shall be notified to the user and the user's authorization shall be obtained in an appropriate manner in accordance with relevant laws and regulations.

For example, when a user's active request is received, prompt information is sent to the user, to explicitly prompt the user that an operation requested by the user needs to acquire and use the user's personal information. In this way, the user can independently choose, based on the prompt information, whether to provide the personal information to software or hardware such as an electronic device, an application, a server, or a storage medium that executes the operation of the technical solution of the present disclosure.

As an alternative but non-restrictive implementation, the manner of sending the prompt information to the user in response to the user's active request may be, for example, a pop-up window, and the prompt information may be presented in the pop-up window in text. In addition, the pop-up window may further include a select control for the user to select “Agree” or “Disagree” to provide the personal information to the electronic device.

It may be understood that the foregoing process of notifying and obtaining the user's authorization is merely illustrative, and does not constitute a limitation on the implementation of the present disclosure. Other manners that comply with relevant laws and regulations may also be applied to the implementation of the present disclosure.

Although the embodiments of the present disclosure are described with reference to the accompanying drawings, a person of ordinary skill in the art may make various modifications and variations without departing from the spirit and scope of the present disclosure, and such modifications and variations fall within the scope defined by the appended claims.

What is claimed is:

1. A method for data query, comprising:
displaying a data query page, wherein the data query page comprises a data query control;
obtaining a data query statement based on an interaction with the data query control, and displaying the data query statement on the data query page; and
displaying, on the data query page and based on the data query statement, a message card representing a query result, wherein the message card comprises a query condition area and a visual display area, the query condition area is configured to display a query condition corresponding to the data query statement, and the data visual display area is configured to display data corresponding to the query condition.

2. The method of claim 1, wherein, in response to determining that the number of the query conditions are multiple, the query condition area is configured to display a query condition corresponding to the data query statement, comprising:
displaying, in the query condition area, query logic corresponding to a plurality of query conditions, wherein the query logic is a text formed by arranging the plurality of query conditions in a natural language, and the query condition comprises a condition name and a corresponding value range.

3. The method of claim 2, wherein the query condition area further comprises a query condition edit control, and the method further comprises:
displaying a query condition edit area in response to an interaction with the query condition edit control, wherein the query condition edit area is configured to display an editable control corresponding to the query condition.

4. The method of claim 3, wherein, in the query condition edit area, a mandatory query condition is marked with a first identifier, and an optional query condition is marked with a second identifier, and the method further comprises:
identifying an editable control to be selected in the query condition edit area;
in response to determining that the query condition corresponding to the editable control to be selected is an optional query condition, displaying a deletion control on a specified area of the editable control to be selected;
deleting the editable control to be selected in response to an interaction with the deletion control;
in response to determining that the query condition corresponding to the editable control to be selected is a mandatory query condition, not displaying the deletion control; and
updating the query condition edit area based on a currently retained editable control.

5. The method of claim 4, wherein the query condition edit area further comprises an add control, and the method further comprises:
displaying a condition menu in response to an interaction with the add control, wherein the condition menu is configured to provide a plurality of candidate query conditions and a condition detail page corresponding to the candidate query condition, and the condition detail page is configured to determine a condition name of the candidate query condition and/or a value range corresponding to the condition name.

6. The method of claim 5, wherein the method further comprises:
determining an added query condition, wherein the added query condition is a candidate query condition that is selected to be added; and
adding an editable control corresponding to the added query condition to the query condition edit area, to update the query logic.

7. The method of claim 4, wherein the query condition edit area further comprises an area controlling control, and the method further comprises:
determining, in response to an interaction with the area controlling control, a current query condition corresponding to a current editable control in the query condition edit area, and hiding the query condition edit area; and
updating the query logic based on the current query condition, and displaying the updated query logic in the query condition area.

8. The method of claim 1, wherein the visual display area comprises a chart function operation area and a data visualization area, the chart function operation area comprises a chart type menu, and the data visual display area is configured to display data corresponding to the query condition, comprising:
determining a target chart type in response to an interaction with the chart type menu, wherein the target chart type is a candidate chart type that is selected from a plurality of candidate icon types;
generating a target chart based on the target chart type, wherein the target chart is configured to represent the data corresponding to the query condition; and
displaying the target chart in the data visualization area.

9. The method of claim 8, wherein the chart function operation area further comprises a plurality of function operation controls, and the method further comprises:
performing, in response to an interaction with a target function operation control, an operation function corresponding to the target function operation control; and
wherein the target function operation control is a selected function operation control.

10. The method of claim 9, wherein, in response to determining that the target function operation control is a code query control, the operation function corresponding to the target function operation control comprises: calling and displaying execution code for generating the target chart.

11. The method of claim 9, wherein the chart function operation area further comprises a function menu; the plurality of function operation controls comprises a first function operation control and a second function operation control, wherein the first function operation control is directly displayed in the chart function operation area, and the second function operation control is hidden in the function menu;
the method further comprises:
displaying the second function operation control in response to an interaction with the function menu.

12. The method of claim 9, wherein the data visualization area further comprises a data anomaly control, the data anomaly control is configured to display an anomaly detection result in the query result, and the method further comprises:
displaying an anomaly detail page of the anomaly detection result in response to an interaction with the data anomaly control.

13. The method of claim 1, wherein the message card further comprises a function recommendation area, the function recommendation area is configured to display a data summary control, and the method further comprises:
generating and displaying a data summary text of the query result in response to an interaction with the data summary control.

14. The method of claim 1, wherein the data query page further comprises a configuration menu, and the method further comprises:
displaying a display attribute detail page of the message card in response to an interaction with the configuration menu, wherein the display attribute detail page is configured to adjust display content of the message card.

15. The method of claim 1, wherein before obtaining a data query statement, the method further comprises:
receiving a current input content that is input in the data query control;
identifying whether there is an ambiguous query condition in the current input content; and
in response to the existence of the ambiguous query condition, displaying an edit control for the ambiguous query condition on the data query page, to prompt to modify the ambiguous query condition.

16. The method of claim 15, wherein the method further comprises:
displaying a disambiguation detail page in response to an interaction with the edit control, wherein the disambiguation detail page is configured to provide a plurality of related query conditions associated with the ambiguous query condition;
determining a currently selected related query condition; and
replacing the ambiguous query condition with the currently selected related query condition, to update the current input content and obtain the data query statement.

17. The method of claim 16, wherein, in response to determining that the related query condition is not selected, before displaying, on the data query page, a message card representing a query result, the method further comprises:
displaying a disambiguation card, wherein the disambiguation card comprises a plurality of condition selection controls, different condition selection controls correspond to different related query conditions; and
updating the data query statement based on the currently selected related query condition in response to the currently selected related query condition.

18. A computer device, comprising:
a memory and a processor, wherein the memory and the processor are in communication connection with each other, computer instructions are stored in the memory, and the processor executes the computer instructions to:
display a data query page, wherein the data query page comprises a data query control;
obtain a data query statement based on an interaction with the data query control, and displaying the data query statement on the data query page; and
display, on the data query page and based on the data query statement, a message card representing a query result, wherein the message card comprises a query condition area and a visual display area, the query condition area is configured to display a query condition corresponding to the data query statement, and the data visual display area is configured to display data corresponding to the query condition.

19. The device of claim 18, wherein the device is further caused to, in response to determining that the number of the query conditions are multiple, configure the query condition area to display a query condition corresponding to the data query statement by:
displaying, in the query condition area, query logic corresponding to a plurality of query conditions, wherein the query logic is a text formed by arranging the plurality of query conditions in a natural language, and the query condition comprises a condition name and a corresponding value range.

20. A non-transitory computer-readable storage medium, wherein the computer-readable storage medium is stored with computer instructions, and the computer instructions causes a computer to:
display a data query page, wherein the data query page comprises a data query control;
obtain a data query statement based on an interaction with the data query control, and displaying the data query statement on the data query page; and
display, on the data query page and based on the data query statement, a message card representing a query result, wherein the message card comprises a query condition area and a visual display area, the query condition area is configured to display a query condition corresponding to the data query statement, and the data visual display area is configured to display data corresponding to the query condition.
